(19) United States
(12) Patent Application Publication
(10) Pub. No.: US 2009/0055233 A1
(43) Pub. Date: Feb. 26, 2009

(54) Method and Device for Transporting an Item

(75) Inventors: Thorsten Lamprecht, Winterthur (CH); Harald Mebold, Konstanz (DE)

Correspondence Address: LERNER GREENBERG STEMER LLP, P O BOX 2480, HOLLYWOOD, FL, 33022-2480, US

(73) Assignee: SIEMENS AKTIENGESELLSCHAFT, Munich (DE)

(21) Appl. No.: 12/197,493

(22) Filed: Aug. 25, 2008

(30) Foreign Application Priority Data
Aug. 24, 2007 (DE) 10 2007 040 157.6

(51) Int. Cl. G06Q 10/00

(52) U.S. Cl. 705/7

(57) ABSTRACT

A method and a device for transporting an item to a destination location. The item is provided with a label bearing the destination location to which the item is to be transported. The item is additionally provided with a label bearing a transportation service provider. The item is transported to a sorting plant and passes through the sorting plant. Information about the destination location with which the item is labeled is input into a data acquisition system of the sorting plant. It is automatically decided whether a preset error signal for a transportation error was or was not input during passage of the item. Depending on the destination location data which has been input, the sorting plant triggers onward transportation of the item to the destination location. In the event of the error signal for a transportation error having been input, a report is generated. This report describes the transportation error, comprises the input destination-location data, and is transmitted to the transportation service provider which triggered the transportation to the sorting plant.

### CROSS-REFERENCE TO RELATED APPLICATION

This application claims the priority, under 35 U.S.C. § 119, of German patent application DE 10 2007 040 157.6, filed Aug. 24, 2007; the prior application is herewith incorporated by reference in its entirety.

### BACKGROUND OF THE INVENTION

### Field of the Invention

The invention relates to a method and a device for transporting an item to a destination location. The item in question, may be, in particular, a postal consignment bearing a delivery address.

A method and a device of the generic kind are described in German published patent application DE 10043752 A1. There, a method for transporting an item to a destination location (the item bearing a label identifying the destination location and a label identifying a transportation service provider) includes the following steps: inputting information about the destination location, with which the item is labeled, into a data acquisition system, and triggering onward transportation of the item to the destination location, depending on the destination location data input. A computer-evaluable report on a transportation error is generated in the event of a transportation error and transmitted to a data-processing unit of a transportation service provider.

The device designed for controlling the transportation of the item to the destination location includes a data acquisition system. The data acquisition system is designed for the purpose of acquiring information about the destination location with which the item is labeled, and the device is designed for the purpose of triggering onward transportation of the item to the destination location depending on the destination location data input. In the event of a transportation error, the device generates a computer-evaluable report on the transportation error and transmits same to a data-processing unit of the transportation service provider.

Therein a method and a device for handling logistics processes and for tracking postal consignments are described. Each transported piece of merchandise is provided with a contactlessly recordable data memory device, e.g. an RFID transponder. During transportation, the transported item is transferred from one transportation means to another transportation means via a logistics chain. At the start of the transportation, data relating to the logistics chain and initial status data are recorded in their RFID transponder. Each time the transported item is transferred, further data are recorded on to the RFID transponder, e.g. a confirmation for transfer to the further transportation means. In one embodiment, RFID reading devices are connected along the logistics chain to a central system. This central system compares preset reference states with actual data. In the event of discrepancies, an alarm is sent to the sender or to an affected transportation company.

German patent DE 10006242 B4, corresponding to U.S. Pat. No. 7,392,198 B2, describes a method for monitoring and logging the transportation of postal consignments. Each consignment is labeled with a unique identifier and passes through a plurality of sorting plants during transportation. For each consignment a data set is created in the originating sorting plant. The route of the postal consignment through the sorting plants is plotted. The results of these plots are fed back to the originating sorting plant. This continually updates the data set for the postal consignment.

### SUMMARY OF THE INVENTION

Is an object of the invention is to provide a method as summarized above and a corresponding device which avoids the short-comings of the prior art and provides for an improved method and device that avoids interruption of the processing chain in the event of transportation errors.

With the above and other objects in view there is provided, in accordance with the invention, a method of transporting an item to a destination location, the item bearing a label identifying the destination location and a label identifying a transportation service provider, the method which comprises:

inputting information about the destination location, with which the item is labeled, into a data acquisition system, and

triggering onward transportation of the item to the destination location, depending on the destination location data input,

a computer-evaluable report on the transportation error being generated in the event of a transportation error and transmitted to a data-processing unit of a transportation service provider.

The improvement comprises:

transporting the item at least once to a sorting plant after having been labeled with the label identifying the transportation service provider;

the sorting plant including the data acquisition system;

passing the item through the sorting plant;

triggering onward transportation of the item with the sorting plant depending on the destination location data input;

automatically deciding whether or not a preset error signal for a transportation error was input into the data acquisition system during passage of the item through the sorting plant; and

if the input of the error signal has been ascertained, automatically performing the following steps:

identifying the transportation service provider by acquiring the information from the label identifying the transportation service provider applied to the item; and

generating the computer-evaluable report containing the destination location data input.

In other words, the item is given a label bearing the destination location to which the item is to be transported. Furthermore, the item is additionally labeled with a label bearing a transportation service provider.

The following steps are performed:

The item is transported to a sorting plant at least once.

The item passes through the sorting plant.

Information about the destination location with which the item is labeled is input into a data acquisition system of the sorting plant.

It is automatically decided whether a preset error signal for a transportation error was or was not input into the data acquisition system during passage of the item.

Depending on the destination location data which has been input, the sorting plant triggers onward transportation of the item to the destination location.

In the event of the error signal for a transportation error having been input, a report on the transportation error is generated. This report describes the transportation error and comprises the input destination-location data.

This report is transmitted to the transportation service provider which triggered the transportation to the sorting plant in which transportation error was discovered. The label of the transportation service provider attached to the item is evaluated in order to identify this transportation service provider.

By this means this transportation service provider is enabled to avoid future transportation errors.

The invention saves having to remove the item from normal processing in the sorting department when a transportation error is discovered. Rather, the item is further processed in the normal way. The steps of inputting and automatically recognizing an error signal do not interrupt the normal operation. The item—together with other items passing through the sorting plant—is processed and transported to the correct destination location. In parallel with this processing chain, the report is released to the transportation service provider.

This is achieved inter alia in that the error signal is input into the same data acquisition system into which details about the destination location are also input. It is therefore not necessary to switch between different data acquisition systems in order to input on the one hand the destination location data and on the other an error signal.

Admittedly the invention does save the need to provide each item with a data memory device, e.g. a contactlessly readable data memory device, and to read the data in this data memory device and compare them with centrally stored reference data. Even without such a data memory device it is possible to determine to which transportation service provider the report on the transportation error is to be transmitted. The invention thus does away with data memory devices and reading devices for such data memory devices.

The item is for example a parcel, a package or some other postal consignment. In another application, the item is the luggage of a traveler which is transported within an airport or a railway station or a port to a destination airport or destination railway station or destination port separately from the traveler.

In one embodiment, the identifier of the transportation service provider, with which the item to be transported is labeled, is machine-readable, e.g. a bar code or matrix code. In another embodiment, the identifier is also readable by a person, for example a written label or a logo.

It is also possible for the item to be provided with a unique identifier which differentiates this item from all other items passing through the sorting plant within a specific period. The identifier is, for example, a bar code or another machine-readable identifier. A data set for the item is saved in a central database. This data set includes the identifier for the item and an identifier for the transportation service provider. The step of identifying the transportation service provider comprises the steps of reading the item's identifier, searching for and finding the data set for the item in the central data base, and identifying the transportation service provider by evaluating this data set.

The data acquisition system preferably comprises a system for detecting and evaluating spoken language. The step of inputting the destination location data about the item comprises the step of inputting this target-location data into the data acquisition system by speech input and of the said data acquisition system evaluating the input speech. The error signal is input in the same way, namely by inputting a predetermined word or word sequence into the data acquisition system by speech input.

This embodiment makes it possible to use an incidentally present data acquisition system additionally for the error input. It is not necessary to provide an additional, separate error-input system. This saves the expense of having to provide and use an additional system. This embodiment furthermore requires an especially small expense for dealing with an incorrectly transported item.

However, it is also possible for a dedicated error detection system to be provided, in which a button provided specifically for the purpose is pressed in order to announce the occurrence of an error.

With the above and other objects in view there is also provided, in accordance with the invention, a device for controlling a transportation of an item (bearing a label identifying the destination location and a label identifying a transportation service provider) to a destination location, the device comprising:

a sorting plant configured to have the item with the label identifying the transportation service provider pass therethrough;

the sorting plant including a data acquisition system configured to acquire information about the destination location with which the item is labeled, and to automatically decide whether or not a preset error signal for a transportation error was input during passage of the item;

the sorting plant triggering onward transportation of the item to the destination location depending on the destination location data input; and

if the data acquisition system establishes that an error signal has been input, the sorting plant automatically performing the following steps:
identifying the transportation service provider by identifying the label of the transportation service provider applied to the item;
identifying the transportation service provider by identification of the label of the transportation service provider applied to the item;
generating a report on the transportation error, the report including the destination location data input; and
triggering a transmission of the report to the transportation service provider.

Other features which are considered as characteristic for the invention are set forth in the appended claims.

Although the invention is illustrated and described herein as embodied in method and device for transporting an item, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawing.

### BRIEF DESCRIPTION OF THE DRAWING

FIGS. 1A and 1B are two partial views of a diagram showing an operation sequence during the transportation of a parcel.

### DETAILED DESCRIPTION OF THE INVENTION

In the exemplary embodiment the invention is used to transport postal consignments, in particular parcels and packages. Each postal consignment is provided with a label bearing a delivery address. The respective delivery address functions as the destination location to which the postal consignment is to be transported.

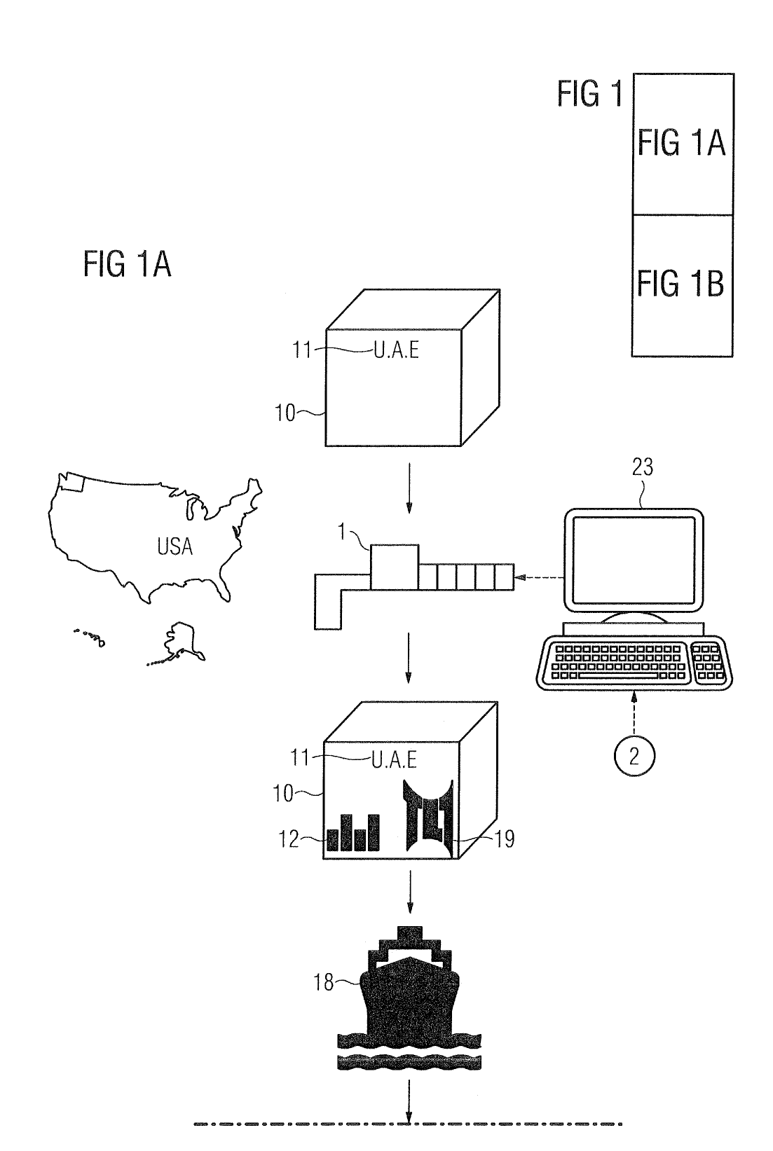

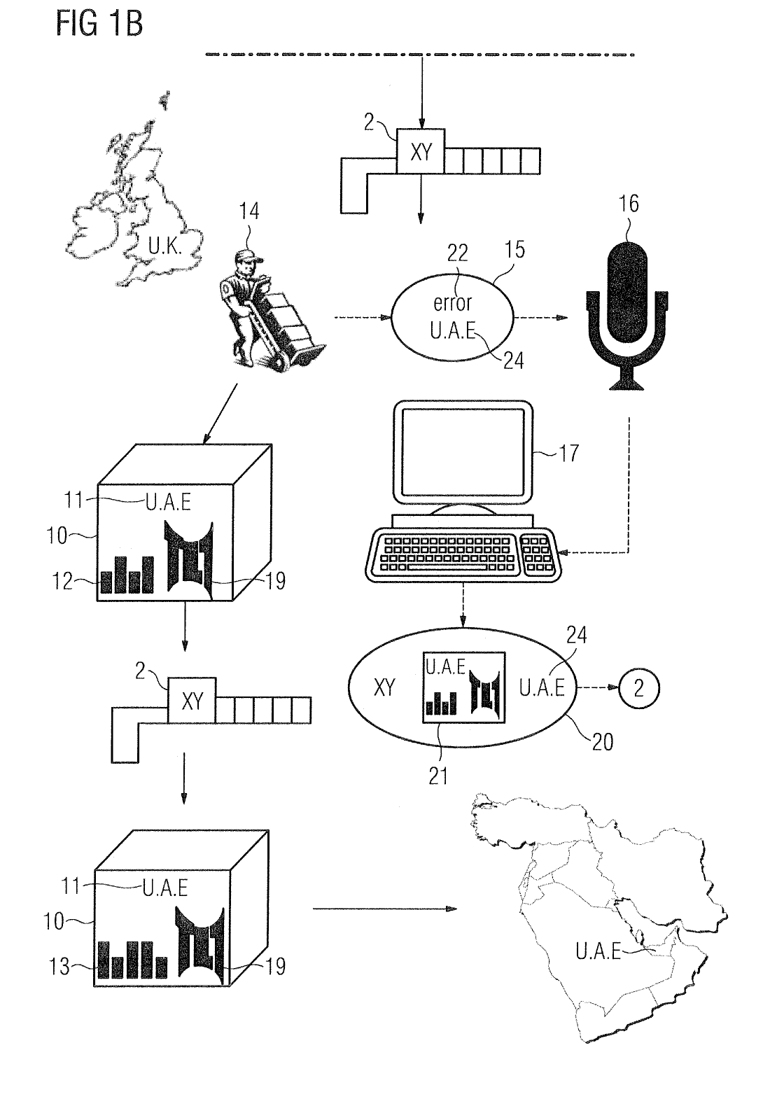

In the example of FIG. 1, a parcel 10 is handed in the USA. The parcel is provided with a label bearing a delivery address, in this case a place in the United Arab Emirates (UAE). In the figure, flows of materials are represented with solid lines and flows of data with dashed lines.

Each postal consignment is passed to a first transportation service provider in a post office or parcel-sorting shelf system where the item was posted. The postal consignment may also originate from a mailbox or dropbox. This first transportation service provider functions as the transportation service provider of the claims and operates at least one first sorting plant. All postal consignments from the post office or parcel-sorting shelf system of postage are given a label identifying the first transportation service provider and pass through this first sorting plant. The label is for example in the form of a logo which differentiates the first transportation service provider from other businesses.

In the example of the figure, the parcel 10 arrives at a first sorting plant 1 of a transportation service provider TL1. This first sorting plant 1 gives the parcel a label 19 in the form of a logo for TL1.

The postal consignment 10 is given the label, for example, when the postal consignment is handed over in the post office or parcel-sorting shelves where it is posted. It is also possible for the first sorting plant 1 to provide the postal consignment 10 with a label identifying the first transportation service provider.

In a preferred embodiment, the postal consignment is labeled with a unique identifier which comprises the identifier of the transportation service provider and a further identifier. The further identifier differentiates the postal consignment from all other postal consignments which the first transportation service provider transports within a predetermined time period. The first sorting plant preferably generates this identifier.

In a development of this embodiment, a data set is filed for the postal consignment in a central database. This data set comprises the unique identifier with the label of the transportation service provider and the further identifier.

The first sorting plant 1 identifies the respective label 11 with the delivery address of each postal consignment 10 which passes through the sorting plant 1. It first of all attempts to recognize the delivery address automatically.

If this does not succeed or does not succeed unequivocally, in one embodiment an image of the postal consignment 10 comprising the label 11 with the delivery address is generated. This image is transmitted to a first video coding station. The first video coding station displays the image on a display unit. An operator identifies the delivery address on the display and enters it.

In one embodiment, the first sorting plant 1 generates a bar code which encodes the delivery address. A printer in the first sorting plant 1 adds the bar code to the postal consignment.

In the example shown in the figure, the first sorting plant 1 does not recognize the label 11 with the delivery address on the parcel 10 correctly. The actual delivery address is in the United Arab Emirates (UAE). However, owing to a reading error the first sorting plant 1 identifies a false delivery address within the United Kingdom (UK). The first sorting plant 1 gives the parcel 10 a bar code 12 which encodes for the UK, and decides that the parcel 10 has to be transported to the UK. The first transportation service provider T1 fails to notice this transportation error.

After the delivery address has been identified, the first sorting plant 1 triggers onward transportation of the postal consignment 10 to the delivery address. In the development described above with the central database, the first sorting plant 1 updates the data set for the postal consignment with the identified delivery address.

In the example shown in the figure, the first sorting plant 1 triggers transportation of the parcel 10 to the UK. The parcel 10 is conveyed to the UK on the vessel 18. There the parcel 10 is transported from the vessel 18 to a second sorting plant 2 and passes through this second sorting plant 2. This second sorting plant 2 functions as the sorting plant within the meaning of the claims.

The second sorting plant 2 is responsible for forwarding those postal consignments whose delivery address lies within the catchment area of the second sorting plant. In the exemplary embodiment, the second sorting plant 2 is operated by a second transportation service provider, TL2 and the first sorting plant 1 by a first transportation service provider, TL1.

For example, the postal consignment is sent from a country A to another country B. The delivery address is therefore in country B. The first sorting plant 1 is in country A, and the second sorting plant in country B. In the example shown in the figure, the first sorting plant 1 is in the USA. The second sorting plant 2 is responsible for all postal consignments which come from abroad and—in accordance with a result of a preceding transportation step—are to be delivered to a delivery address in the UK. Therefore all postal consignments from abroad to the UK pass through this second sorting plant 2.

The second sorting plant 2 identifies the delivery address on the postal consignment 10. In one embodiment, the delivery address is read again, e.g. by an operator. In another embodiment, the second sorting plant 2 reads a bar code which has been applied to the postal consignment 10 and encodes the delivery address—or at least the destination country.

In a further embodiment, reading access of the second sorting plant to the central database is created. The second sorting plant 2 detects the identifier of the postal consignment 10 and then the data set which includes this identifier and was therefore set up for this postal consignment 10. The second sorting plant 2 reads the delivery address from the data set.

In the second sorting plant 2, an operative or operator 14 checks at least some of the incoming postal consignments to ascertain whether the respective delivery addresses of these postal consignments are in fact within the catchment area of the second sorting plant 2 or whether a reading error or some other transportation error exists. A transportation error is present especially when a postal consignment 10 to a delivery address Z in fact passes through the second sorting plant 2, although when conveyed correctly postal consignments to Z should not pass through the second sorting plant 2.

The actual delivery address of each postal consignment 10 is indicated to the operator 14 for checking. The second sorting plant 2 comprises a data acquisition system. The operator 14 inputs data into this data acquisition system. Then, if he or she establishes that a transportation error has occurred during the transportation of the transient postal consignment, he or she inputs an error signal. This error signal is linked to the transient postal consignment.

In one embodiment, an image is generated of the surface of the postal consignment bearing the delivery address. This image with the delivery address is shown on a monitor of a video coding station. The data acquisition system forms part of the video coding station and comprises a keyboard. The operator presses a specific key in order to input the error signal.

Another embodiment is used in particular when the postal consignment 10 is a parcel. In this case, the operator 14 reloads the postal consignment while it is passing through the second sorting plant 2, and checks it while doing so. The operator 14 is provided with a portable speech input device. This speech input device comprises a microphone 16 and headphones via which instructions are given to the operator 14. If the operator 14 establishes that an error has occurred in a preceding transportation process, he or she speaks a preset key word into the microphone, e.g. “error” or “fault.”

In the example shown in the figure, parcels from the USA to the United Arab Emirates are transported not via the UK but directly from the USA to Arabia. The operator 14 monitors all postal consignments which arrive in the UK from abroad and therefore pass through the second sorting plant 2. During this monitoring operation, the operator 14 establishes that the postal consignment 10 was transported to the UK in error. A transportation error is therefore present in a preceding transportation process.

Then, when he or she notices such a transportation error, the operator 14 inputs an error signal 22 via a speech input system by pronouncing the word “error.” He or she also inputs data 24 relating to the correct delivery address, in this case therefore by announcing and thereby inputting “United Arab Emirates.” Overall, a verbal report 15 is input into a microphone 16 and processed by the data acquisition system. This data acquisition system possesses a speech processing system, which runs on a data-processing unit 17 of the second sorting plant 2.

The data acquisition system automatically checks whether a preset error signal 22 for a transportation error was or was not input during passage of the postal consignment 10. As soon as the data acquisition system has established that an error signal 22 has been input, the data-processing unit 17 of the second sorting plant 2 initiates the following steps:
The identifier 19 applied to the postal consignment 10 in the form of a logo of the first transportation service provider is detected.
A report 20 about the transportation error is generated.
A data base is searched for an e-mail address or postal address of the transportation service provider TL1 which labels postal consignments with the logo 19.
The report 20 is sent to a data-processing unit 23 of the first transportation service provider TL1.

The second sorting plant 2 identifies the label 19 of the first transportation service provider TL1, the said label 19 being attached to the postal consignment, by searching for a logo or some other label 19 of the first transportation service provider TL1. Or it evaluates an identifier of the postal consignment 10, which identifier comprises a label of the first transportation service provider TL1. Or it searches the central database for a data set for the postal consignment 10 and identifies the first transportation service provider TL1 by reading access to this data set.

The second sorting plant 2 generates an image 21 of the postal consignment 10. In the exemplary embodiment, the report 20 sent to the first transportation service provider TL1 comprises
an image 21 of postal consignment 10,
the details 24 of the delivery address input into the data acquisition system,
if applicable, the label 19 of the first transportation service provider TL1, the said the label 19 being attached to the postal consignment,
an identifier XY of the second sorting plant 2, in which the transportation error was discovered.

The image 21, which is inserted into the report 20 comprises, in the example of FIG. 1
an image of the label 11 with the delivery address,
an image of the bar code 12, which the first sorting plant 1 has erroneously printed, and
an image of the logo 19 of the first transportation service provider TL1.

The second sorting plant 2 performs these steps automatically without interrupting the further conveyance of the wrongly directed postal consignment 10. Rather, the second sorting plant 2 triggers transportation of the postal consignment 10 to the delivery address recognized by or in the second sorting plant 2. In the example of FIG. 1, the second sorting plant 2 generates a bar code 13 which encodes the destination country “United Arab Emirates” and applies this bar code 13 to the parcel 10. This bar code 13 replaces the bar code 12 which the first sorting plant 1 wrongly applied.

1. In a method of transporting an item to a destination location, the item bearing a label identifying the destination location and a label identifying a transportation service provider, the method which comprises:
inputting information about the destination location, with which the item is labeled, into a data acquisition system, and
triggering onward transportation of the item to the destination location, depending on the information about the destination location,
a computer-evaluable message on the transportation error being generated in the event of a transportation error and transmitted to a data-processing unit of a transportation service provider;
the improvement which comprises:
transporting the item at least once to a sorting plant after having been labeled with the label identifying the transportation service provider;
the sorting plant including the data acquisition system;
passing the item through the sorting plant;
triggering onward transportation of the item with the sorting plant depending on the destination location data input;
automatically deciding whether or not a preset error signal for a transportation error was input into the data acquisition system during passage of the item through the sorting plant; and
if the input of the error signal has been ascertained, automatically performing the following steps:
identifying the transportation service provider by acquiring the information from the label identifying the transportation service provider applied to the item; and
generating the computer-evaluable message containing the destination location data input.

2. The method according to claim 1, which comprises:
inputting the destination location data into the data acquisition system by speech input; and
inputting the error signal by inputting a word or a word sequence into the data acquisition system by speech input.

3. The method according to claim 1, which comprises assigning an identifier to the sorting plant and incorporating the identifier of the sorting plant into the message transmitted to the transportation service provider.

4. The method according to claim 1, which comprises, during passage of the item, generating an image of the item, and incorporating the image into the message transmitted to the transportation service provider.

5. The method according to claim 4, which comprises:
transmitting the image to a video coding station, the data acquisition system being a component of the video coding station;
displaying the image with the video coding station on a display unit; and
inputting the destination location data using the displayed image.

6. The method according to claim 1, which comprises incorporating the identified label of the transportation service provider into the message transmitted to the transportation service provider.

7. The method according to claim 1, which comprises:
providing the item with a label of the transportation service provider, including the partial steps of:
providing the item with an identifier;
generating a data set with the identifier of the item and with a label of the transportation service provider and storing same in a central data base; and
wherein the step of identifying the label of the transportation service provider applied to the item comprises the partial steps of
detecting the identifier of the item;
creating reading access to the central data base; and
identifying the data set with the detected item identifier and reading out the label of the transportation service provider.

8. A device for controlling a transportation of an item to a destination location,
the item bearing:
an identification identifying the destination location; and
an identification identifying a transportation service provider;
the device comprising:
a sorting plant configured to have the item with the identification identifying the transportation service provider pass therethrough;
said sorting plant including a data acquisition system configured to acquire information about the destination location with which the item is labeled, and to automatically decide whether or not a preset error signal for a transportation error was input during passage of the item;
said sorting plant triggering onward transportation of the item to the destination location depending on the information about the destination location; and
if said data acquisition system establishes that an error signal has been input, said sorting plant automatically performing the following steps:
identifying the transportation service provider by identifying the transportation service provider identified on the item;
generating a report on the transportation error, the report including the destination location data input; and
triggering a transmission of the report to the transportation service provider.

9. The device according to claim 8, wherein said sorting plant is configured to incorporate the identification of the transportation service provider into the report transmitted to the transportation service provider.

10. The device according to claim 8, wherein said sorting plant is further configured to:
additionally generate an image of the item during passage of the item; and
incorporate the image into the report transmitted to the transportation service provider.

11. A method of transporting an item to a destination location, the item bearing an identification identifying the destination location and an identification identifying a transportation service provider, the method which comprises:
transporting the item at least once to a sorting plant after having been provided with the identification identifying the transportation service provider, passing the item through the sorting plant, and inputting information about the destination location, with which the item is identified, into a data acquisition system of the sorting plant;
triggering onward transportation of the item to the destination location with the sorting plant, depending on the information about the destination location;
automatically deciding whether or not a preset error signal for a transportation error was input into the data acquisition system during passage of the item through the sorting plant; and
if the input of the error signal has been ascertained, automatically performing the following steps:
identifying the transportation service provider by acquiring the information from the identification identifying the transportation service provider applied to the item; and
generating a computer-evaluable message on the transportation error containing the destination location data input, and transmitting the message to a data-processing unit of the transportation service provider.

12. The method according to claim 11, which comprises incorporating the identification of the transportation service provider acquired in the identification step into the message transmitted to the transportation service provider.

13. The method according to claim 11, which comprises:
providing the item with an identification identifying the transportation service provider, including the partial steps of:
providing the item with an identifier;
generating a data set with the identifier of the item and with an identification of the transportation service provider and storing same in a central data base; and
wherein the step of identifying the transportation service provider comprises the partial steps of:
detecting the identifier of the item;
creating reading access to the central data base; and
identifying the data set with the detected item identifier and reading out the label of the transportation service provider.
